(19) United States
(12) Patent Application Publication
(10) Pub. No.: US 2002/0095994 A1
(43) Pub. Date: Jul. 25, 2002

(54) Tissue fatigue apparatus and system

(76) Inventors: Ivan Vesely, Cleveland Heights, OH (US); Evan Anderson, Cleveland, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 09/950,542

(22) Filed: Sep. 10, 2001

Related U.S. Application Data
(60) Provisional application No. 60/231,288, filed on Sep. 8, 2000.

(51) Int. Cl. G01N 3/32

(52) U.S. Cl. 73/808

(57) ABSTRACT

An apparatus for fatigue testing a material comprising a first clamp and a second clamp to secure the material, means for rotating the first clamp in one direction relative to the second clamp and means for rotating the second clamp in an opposite direction relative to the first clamp thereby bending the material, and a pair of cam mechanisms for translating the first and second clamps in opposite directions thereby stretching the material. The apparatus is capable of bending and stretching the material within one complete cycle.

### BACKGROUND OF THE INVENTION

The human heart functions to pump blood through the body, thereby delivering nutrients to tissues and removing waste. The right half of the heart receives blood from the veins and pumps it through the lungs while the left half pumps blood to the arteries. Each of the two halves of the heart contains two chambers, an atrium and a ventricle, separated by valves that are designed to allow blood flow in only one direction. In the first phase of the cardiac cycle (diastole) the heart relaxes and passively fills with blood. In the second phase (systole) the heart contracts to generate pressure for pushing blood through the body. It is important for the heart valves to function properly otherwise pumping is inefficient and a portion of the blood may flow back through the valve. This backflow is called regurgitation.

The heart has two types of valves: atrioventricular and semilunar. The atrioventricular valves enable flow from the atria into the ventricles during diastole and prevent flow from the ventricles to the atria in systole. These valves, the tricuspid on the right side and mitral on the left, have chordae that connect to the myocardium and assist in valve closure. The semilunar valves, the pulmonary on the right and aortic on the left, consist of three cusps that open and close to prevent backflow into the ventricle during diastole. The cusps are pocket-like flaps that connect to the walls of the heart.

In anatomical study of aortic valve cusps two major directions are used to define the orientation of each cusp: circumferential and radial. The circumferential direction runs parallel to the aortic wall while the radial direction runs from the center of the cusp to the edge of the aorta. These directions are used as opposed to Cartesian coordinates because the cusps are symmetrical about the central axis of the valve. Each cusp has a small fibrocartilaginous nodule at the midpoint of the free edge of the cusp, called corpus Arantii or Nodulus Arantii. This nodulus helps seal the orifice during closure. Also, the cusps are longer than necessary for contact and extend in the direction of blood flow for a distance of several millimeters from the upper edge to ensure a good seal. This is referred to as “leaflet coaptation.” The coaptation region is the area of contact between the neighboring cusps. Each cusp is attached to the aorta along its curved, lower margin, while its upper free margin moves with the blood flow and meets with the other cusps along the coaptation region. The uppermost point of attachment of the cusp to the aorta is called the commissure.

When the aortic valve cups were first identified, they were described as a composite tissue with three layers that dictate the mechanics of the whole valve. The three separate layers are the fibrosa, spongiosa and ventricularis. The top layer, the fibrosa, consists mostly of bundles of collagen fibers arranged in a circumferential direction, from commissure to commissure. The fiber orientation makes the fibrosa approximately four to six times stiffer in the circumferential direction than in the radial direction. It is believed the purpose of the fibrosa is to absorb stress during expansion of the closed valve, allowing the cusp to resist high blood pressures. The spongiosa is located between the fibrosa and ventricularis and consists of water, collagen, elastin, proteoglycans and hyaluronan. Its exact function is unknown, but it is likely that it acts as a buffer zone to enable localized movement and shearing between the top and bottom layers of the valve. The bottom layer, the ventricularis, is composed of large continuous sheets of amorphous or compact mesh elastin along with collagen. The ventricularis has been found to preload the collagen bundles of the fibrosa, keeping them in a compressed state and allowing them to return to this state after the removal of a load.

When the aortic valve is functioning properly, the three semilunar cusps open and close according to the direction of blood flow. Dysfunction of the aortic valve leading to replacement surgery is due to two main causes: stenosis (restriction of the free opening of the valve) and incompetence (allowing backflow through the closed valve). Aortic valvular disease may be linked to congenital heart defects in 8 to 10 per 1,000 live births. Human heart valves may also fail because of progressive calcification. Over 50,000 heart valves are implanted annually in the United States alone, but information on valve performance is not conclusive since only a small percentage of the information has been compiled. When replacement surgery on dysfunctional aortic valves is done, three major types of aortic valve replacements are used: mechanical prostheses, allografts, and xenografts.

Until recently, mechanical prosthesis valves had been the dominant bioprosthetic valves used in the United States, with a 40-60% market share. They are often used in younger patients because they have the longest durability of the three types of heart valves, but they also have several drawbacks. Their mode of failure can be catastrophic and they require the patient to take anticoagulants to prevent thromboembolism. Patients taking anticoagulants are susceptible to serious hemorrhage, particularly retroperitoneal, gastrointestinal, or cerebral at an incidence rate of approximately 4% per patient-year.

Tissue valves (i.e., bioprostheses) do not require anticoagulant therapy. The first tissue valves used in replacement of diseased heart valve were allografts (also called homografts) valves taken from human cadavers. Allografts are explanted from cadavers within two days of death and are preserved using cryopreservation, freeze drying and incubation in antibiotic solution. These same species valve transplants provide good blood flow characteristics and compatibility, but with the increase in total heart replacement surgeries, the number of human valves available for implantation has decreased.

Xenografts, like allografts, are tissue based replacement valves, but they are obtained from animals other than humans. The animal tissue based valves (i.e., xenografts), such as porcine (pig) aortic valves or bovine (cow) pericardium, often use some type of chemical fixation technique in order to render them non-antigenic in the human body. Initially, formaldehyde fixation was used to treat xenografts, but after the introduction of glutaraldehyde fixation, porcine bioprotheses became commercially available. Glutaraldehyde fixation is used to form covalent crosslinks between the free amines in leaflet proteins, thereby reducing immunogenicity and improving valve durability.

A type of xenograft studied frequently in the Heart Valve Lab, glutaraldehyde-fixed porcine aortic valves (GPV), are often used as replacement valves in humans. The advantage of using biological valves is that unlike mechanical valves, they do not elicit blood clotting and hence do not require patients to undergo anticoagulant therapy. The major problem with GPV, however, is their ultimate failure after an average of 15 years. One reason for the poor durability of bioprosthetic valves is that glutaraldehyde treatment prevents any biological remodeling or repair and makes the tissue stiffer, thicker and less compliant. Cyclic opening and closure therefore subjects the valve to tissue buckling and greater flexural fatigue than normal untreated valves. Studies have linked mechanical stresses on valve cusps with calcification, focal thinning and cusp failure. It has been suggested that valve calcification can cause stiffening and lead to stress concentrations that induce even more mechanical damage, which in turn stimulates further calcification. Ultimately, these valves fail after millions of cycles, through weakening and eventual tearing of the valve cusps, commonly called fatigue failure.

The precise mode of fatigue failure of GPVs remains unclear. It has been hypothesized that cusp bending leads to collagen fiber breakage and overall deterioration of the tissue. The FDA recommends the use of specific fatigue testers created to evaluate replacement heart valves. The standard set by the FDA in 1994 requires artificial valves to be tested to at least 200 million cycles. These testers cycle saline solution through the whole valve in a way similar to physiological conditions, but at an accelerated rate. One parameter of the conventional whole valve fatigue testers that prevents fatigue characterization is they do not subject the valve cusps to physiological or well controlled cusp motion. Another parameter that hampers the fatigue characterization is bioprosthetic heart valves are currently tested from “top down”, meaning that the durability of the valve is tested by whole valve fatigue testers. Therefore, materials to be used in the production of bioprosthetic heart valves have not been compared for their ability to resist fatigue damage induced by stretching and bending in vivo. Because the bioprosthetic heart valve material itself is not isolated and tested separate from the overall design of the replacement valve, the failure mode of a bioprosthetic heart valve cannot be accurately determined. If the material itself is the reason for the premature failure, the current testers will not likely identify this defect in the material.

Currently, durability is based on whole valve fatigue testers that cycle a specimen through 200 million cycles. In order to test multiple specimens, it would be preferable for a fatigue tester to be capable of running several times longer (e.g., 2 billion cycles).

Existing valve fatigue testers run at approximately 20 Hz. In order to test a specimen 200 million times the cycling must be done at an accelerated speed. At 1 Hz (i.e., normal heart rate), 200 cycles would take about 7 years. At 20 Hz, 200 cycles would take approximately 4 months. If the testing is done out of water, a specimen may be stretched and bent at significantly higher speeds. Internal tests within have shown that heart valve tissue may be able to withstand frequencies of 50 Hz if conducted without water. At this rate, 200 million cycles would take approximately 7 weeks. Therefore, 50 Hz is a preferred speed for a new fatigue tester. Tissue motion is perhaps the most important parameter to simulate. From in vivo heart valve studies, we know that valve tissues both stretch and bend at the same time. Stretching and flexure is occurs during normal valve function, but in a controlled accelerated test, biaxial stretching and flexure is difficult to simulate. To simplify the motion, the fatigue tester should stretch the tissue uniaxially by clamping the tissue at each end. In the body, GPV may flex at a small radius of curvature through 180° of motion and stretch under pressure gradients of approximately 80 mmHg. Each piece of tissue is highly variable, but testing leads to the estimate that the maximum amount of stretching needed to simulate physiological condition on a 10 mm piece of tissue would be approximately 6 mm. Therefore, the fatigue tester should stretch the tissue a maximum of 6 mm. This will be enough motion to enact any amount of force on the tissue, up to tissue failure.

### SUMMARY OF THE INVENTION

The present invention is directed to an apparatus that tests the ability of a tissue sample to resist fatigue damage by controllably stretching and bending the tissue sample in vitro.

The apparatus of the present invention is capable of testing the ability of a tissue sample to resist fatigue damage by stretching and bending the tissue sample in vitro. The apparatus according to the present invention is capable of testing the fatigue characteristics of a tissue sample by preferably controlling the bending and stretching of the tissue sample. By controlling the bending and stretching of tissue samples, it will be possible to (i) examine the disruption of the fibers at a specific number of cycles, (ii) quantify overall degradation of the tissue as a function of the cycle number, and (iii) identify the exact mechanism of valve failure. Once this information is known, regions where the valve leaflets are at risk of fatigue can be better identified and design improvements to reduce stress on valve leaflets can be appropriately made. Ultimately, such information will help improve the durability and clinical utility of bioprosthetic valves.

The apparatus of the present invention provides information about fatigue of bioprosthetic valve tissue. This device enables very consistent bending and stretching so that the cumulative effects of these two fatigue modes can be measured. It is believed that bending and stretching together have a greater effect on a tissue sample, than either alone. The flexibility of the apparatus according to the present invention will enable the characterization of fatigue failure by varying the radius of curvature, the degree of bending, and the amount of stretching.

The information thus obtained could facilitate enhancement of prosthetic valve design, and therefore greatly improve the quality of life for people requiring valve replacements. Open-heart valve replacement surgery is a relatively serious procedure, and the risk of mortality increases with repeat procedures. If the durability of bioprosthetic valves could be increased, then more patients could be offered tissue valves without risk of repeat procedures. These patients would benefit from the higher quality of life offered by a tissue valve and they would not be exposed to the risk of catastrophic mechanical valve failure.

The apparatus may also have applications in other areas of engineering. Since the apparatus according to the present invention does not bend the material around a mandrel, as does an abrasion-bending fatigue tester, the apparatus can subject materials to pure bending. Therefore, the potential exists to use this apparatus for the testing of other biological materials, such as artificial ligaments, tendons, skin grafts, and vascular tissue. This apparatus could also be used for bending fatigue tests or crack propagation tests in polymers for industrial applications.

According to the present invention, the apparatus comprises: (1) a first clamp to secure a material; (2) a second clamp to secure the material; (3) means for rotating the first clamp in a direction relative to the second clamp thereby bending the material; (4) means for rotating the second clamp in an opposite direction relative to the first clamp thereby bending the material; and (5) a first cam mechanism for translating the first clamp in a direction away from the second clamp thereby stretching the material. The apparatus is capable of bending and stretching the material within one complete cycle. Preferably, the material is a tissue sample. Preferably, the apparatus is operated at a cycle rate between about 20 Hz and about 50 Hz.

The first cam mechanism comprises a first cam having a lobe, a first cam follower engaging the first cam, and a first lever. The first lever has a first and second end where the first end of the first lever is pivotally connected to the first clamp defining a first clamp pivot point and the second end of the first lever is pivotally connected to the first cam follower.

The apparatus may further comprise a second cam mechanism for translating the second clamp in a direction away from the first clamp thereby stretching the material. The second cam mechanism comprises a second cam having a lobe; a second cam follower engaging the second cam; and a second lever. The second lever has a first and second end wherein the first end of the second lever is pivotally connected to the second clamp defining a second clamp pivot point and the second end of the second lever is pivotally connected to the second cam follower. Preferably, the first and second cam mechanisms stretch the material a controlled amount determined by the size of the lobes on said first and second cams.

The means for rotating the first clamp is a first gear mechanism comprising a first gear and a first link. The first link has a first and second end wherein the first end of the first link is pivotally connected to the first gear and the second end of the first link is pivotally connected to the first clamp defining a first link pivot point. The means for rotating the second clamp is a second gear mechanism comprising a second gear and a second link. The second link has a first and second end wherein the first end of the second link is pivotally connected to the second gear and the second end of the second link is pivotally connected to the second clamp defining a second link pivot point. Preferably, the first gear is meshed with the second gear. Preferably, the first and second gear mechanisms bend the material a controlled amount determined by the distance between the first clamp pivot point and the first link pivot point relative to the radius of the first gear and the distance between the second clamp pivot point and the second link pivot point relative to the radius of the second gear.

The apparatus may further comprise a motor coupled to a first shaft. The first gear and the second cam are coupled to the first shaft thereby associating the first gear mechanism with the second cam mechanism. Also, the apparatus may further comprise a second shaft wherein the second gear and the first cam are coupled to the second shaft thereby associating the second gear mechanism with the first cam mechanism.

Preferably, the apparatus further comprises a base wherein the first lever is pivotally connected to the base defining the first lever pivot point and the second lever is pivotally connected to the base defining the second lever pivot point.

During operation, when the first gear and the second cam are rotated in one direction by the first shaft, the rotation of the first gear in one direction causes (1) the first clamp to pivot about the first clamp pivot point and rotate in an arc in one direction relative to the second clamp; and (2) the second lever to pivot about the second lever pivot point and deflect when the second cam follower engages the lobe on the second cam thereby translating the second clamp in a direction opposite of the first clamp. Also, the meshing of the second gear with the first gear causes the second gear and the first cam to be rotated in an opposite direction. This rotation of the second gear and the first cam in the opposite direction causes (1) the second clamp to pivot about the second clamp pivot point and rotate in an arc in the opposite direction relative to the first clamp; and (2) the first lever to pivot about the first lever pivot point and deflect when the first cam follower engages the lobe on the first cam thereby translating the first clamp in a direction opposite of the second clamp. Preferably, the arc is between about 0° and about 100°.

In another embodiment, the present invention provides for a system for testing multiple material samples comprising: (1) a first clamp and a second clamp to secure a first material sample; (2) a first pair of cam mechanisms connected to the first and second clamps; (3) a first pair of gear mechanisms connected to the first and second clamps; (4) a third clamp and a fourth clamp to secure a second material sample; (5) a second pair of cam mechanisms connected to the third and fourth clamps; and (6) a second pair of gear mechanism connected to the third and fourth clamps. The system is capable of bending and stretching the first and second material samples within one complete cycle.

The first pair of cam mechanisms stretches the first material sample by translating the first and second clamps in opposite directions. The first pair of gear mechanisms includes a first gear and a second gear meshed with the first gear. The first pair of gear mechanisms bends the first material sample by rotating the first and second clamps around the first material sample. The second pair of cam mechanisms stretches the second material sample by translating the third and fourth clamps in opposite directions. The second pair of gear mechanisms includes a third gear meshed with the second gear and a fourth gear meshed with the first and third gears. The second pair of gear mechanisms bends the second material sample by rotating the third and fourth clamps around the second material sample.

The first pair of cam mechanisms comprises: (1) a first and second cam each having a lobe; (2) a first cam follower engaging the first cam; (3) a first lever; (4) a second cam follower engaging the second cam; and (5) a second lever. The first lever has a first end and a second end wherein the first end of the first lever is pivotally connected to the first clamp defining a first clamp pivot point and the second end of the first lever is pivotally connected to the first cam follower. The second lever has a first end and a second end wherein the first end of the second lever is pivotally connected to the second clamp defining a second clamp pivot point and the second end of the second lever is pivotally connected to the second cam follower.

The second pair of cam mechanisms comprises: (1) a third cam and a fourth cam; (2) a third cam follower engaging the third cam; (3) a third lever; (4) a fourth cam follower engaging the fourth cam; and (5) a fourth lever. The third lever has a first end and a second end wherein the first end of the third lever is pivotally connected to the third clamp defining a third clamp pivot point and the second end of the third lever is pivotally connected to the third cam follower. The fourth lever has a first end and a second end wherein the first end of the fourth lever is pivotally connected to the fourth clamp defining a fourth clamp pivot point and the second end of the fourth lever is pivotally connected to the fourth cam follower.

The first pair of gear mechanisms further comprises a first link and a second link. The first link has a first end and a second end wherein the first end of the first link is pivotally connected to the first gear and the second end of the first link is pivotally connected to the first clamp defining a first link pivot point. The second link has a first end and a second end wherein the first end of the second link is pivotally connected to the second gear and the second end of the second link is pivotally connected to the second clamp defining a second link pivot point.

The second pair of gear mechanisms further comprises a third link and a fourth link. The third link has a first end and a second end wherein the first end of the third link is pivotally connected to the third gear, the second end of the third link is pivotally connected to the third clamp. The fourth link has a first end and a second end wherein the first end of the fourth link is pivotally connected to the fourth gear and the second end of the fourth link is pivotally connected to the fourth clamp.

Preferably, the system further comprises a motor coupled to a first shaft wherein the first gear and the second cam are coupled to the first shaft. Preferably, the system further comprises a second shaft wherein the second gear and the first cam are coupled to the second shaft, a third shaft wherein the third gear and the fourth cam are coupled to the third shaft, and a fourth shaft wherein the fourth gear and the third cam are coupled to the fourth shaft.

Preferably, the system further comprises a base wherein (1) the first lever is pivotally connected to the base defining the first lever pivot point; (2) the second lever is pivotally connected to the base defining the second lever pivot point; (3) the third lever is pivotally connected to the base defining the third lever pivot point; and (4) the fourth lever is pivotally connected to the base defining the fourth lever pivot point.

The system may further comprise: (1) a fifth clamp and a sixth clamp to secure a third material sample; (2) a fifth cam follower engaging the fourth cam; (3) a fifth lever; and (4) a sixth lever. The fifth lever has a first end and a second end wherein the first end of the fifth lever is pivotally connected to the fifth clamp and the second end of the fifth lever is pivotally connected to the fifth cam follower, a sixth cam follower engaging the first cam. The sixth lever has a first end and a second end wherein the first end of the sixth lever is pivotally connected to the sixth clamp and the second end of the sixth lever is pivotally connected to the sixth cam follower.

Also, the system may further comprise a fifth link and a sixth link. The fifth link has a first end and a second end wherein the first end of the fifth link is pivotally connected to the second gear and the second end of the fifth link is pivotally connected to the fifth clamp. The sixth link has a first end and a second end wherein the first end of the sixth link is pivotally connected to the third gear and the second end of the sixth link is pivotally connected to the sixth clamp.

The system may further comprise: (1) a seventh clamp and an eighth clamp to secure a fourth material sample; (2) a seventh cam follower engaging the second cam; (3) a seventh lever; (4) an eighth cam follower engaging the third cam; and (5) an eighth lever. The seventh lever has a first end and a second end wherein the first end of the seventh lever is pivotally connected to the seventh clamp and the second end of the seventh lever is pivotally connected to the seventh cam follower. The eighth lever has a first end and a second end wherein the first end of the eighth lever is pivotally connected to the eighth clamp and the second end of the eighth lever is pivotally connected to the eighth cam follower.

Also, the system may further comprise a seventh link and an eighth link. The seventh link has a first end and a second end wherein the first end of the seventh link is pivotally connected to the fourth gear and the second end of the seventh link is pivotally connected to the seventh clamp. The eighth link has a first end and a second end wherein the first end of the eighth link is pivotally connected to the first gear and the second end of the eighth link is pivotally connected to the eighth clamp.

In another embodiment, the system may further include a cycle counter to determine the number of cycles that the system completes, a tissue humidifier to moisten the tissue sample during testing, and a lubrication system to lubricate the moving parts of the system.

Furthermore, the present invention provides for a method of fatigue testing a material comprising the steps of providing an apparatus having a first and second clamp to secure a material, bending the material a controlled amount, and stretching the material a controlled amount. The bending and stretching steps are accomplished within one cycle. The bending step includes rotating the first and second clamps in opposite directions around the material and is accomplished by a pair of gear mechanisms. The stretching step includes translating the first and second clamps in opposite directions and is accomplished by a pair of cam mechanisms.

Additionally, the present invention provides for a method of fatigue testing multiple material samples comprising the steps of providing a system having at least two pairs of clamps to secure at least two material samples, simultaneously bending the at least two material samples a controlled amount; and simultaneously stretching the at least two material samples a controlled amount. The bending and stretching steps are accomplished within one cycle. The bending step is accomplished by a first and second pair of gear mechanisms. The stretching step is accomplished by a first and second cam mechanism. The system is capable of bending and stretching four material samples powered by a single motor.

### BRIEF DESCRIPTION OF THE DRAWINGS

These and other features, aspects, and advantages of the present invention will become better understood with regard to the following description, appended claims, and accompanying drawings where:

FIG. 1 is a top view of the apparatus according to the present invention.

FIG. 2 is a side view of the apparatus according to the present invention.

FIG. 3 is a top view of the cam mechanism according to the present invention.

FIG. 4 is a top view of the gear mechanism according to the present invention.

FIG. 5 is a diagram showing the motion of the clamps and the material bending and stretching resulting from the clamp motion.

FIG. 6 is a diagram of one clamp connected to a rotatable member (e.g., gear) showing the sequence of rotating the clamps through 100° as the rotatable member makes a complete revolution;

FIG. 7 is a diagram of the cam mechanism indicating the stretching motion;

FIG. 8 is a graph of angular position of clamp vs. revolution of the rotatable member when the apparatus is set-up for 90° clamp rotation;

FIG. 9 is a graph of angular position of clamp vs. revolution of the rotatable member when the apparatus is set-up for 100° clamp rotation;

FIG. 10 is a graph of angular position of clamp vs. revolution of the rotatable member when the apparatus is set-up for 100° clamp rotation indicating the cam mechanism over-rotation correction;

FIG. 11 is a top view of the apparatus identifying a theoretical slot that may be provided in the base to adjust the amount of material stretching;

FIG. 12 is a top view of method to adjust the clamps to adjust the amount of material stretching; and

FIG. 13 is a top view of the system according to the present invention that includes four units geared together to simultaneously bend and stretch four material samples driven by one motor.

### DETAILED DESCRIPTION OF THE INVENTION

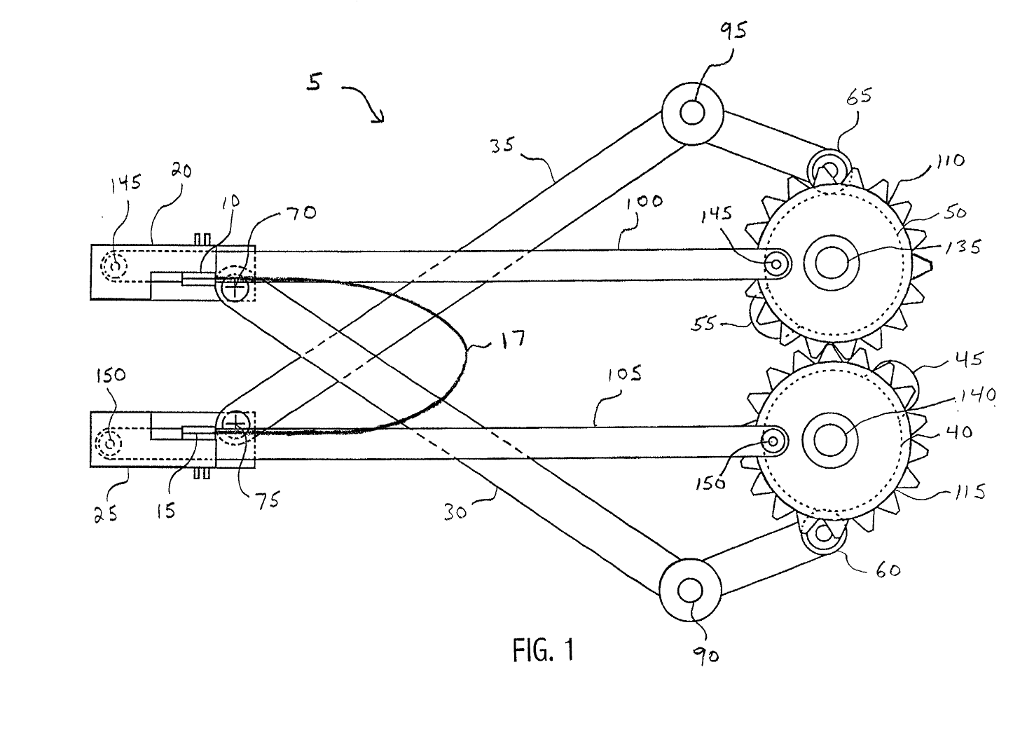

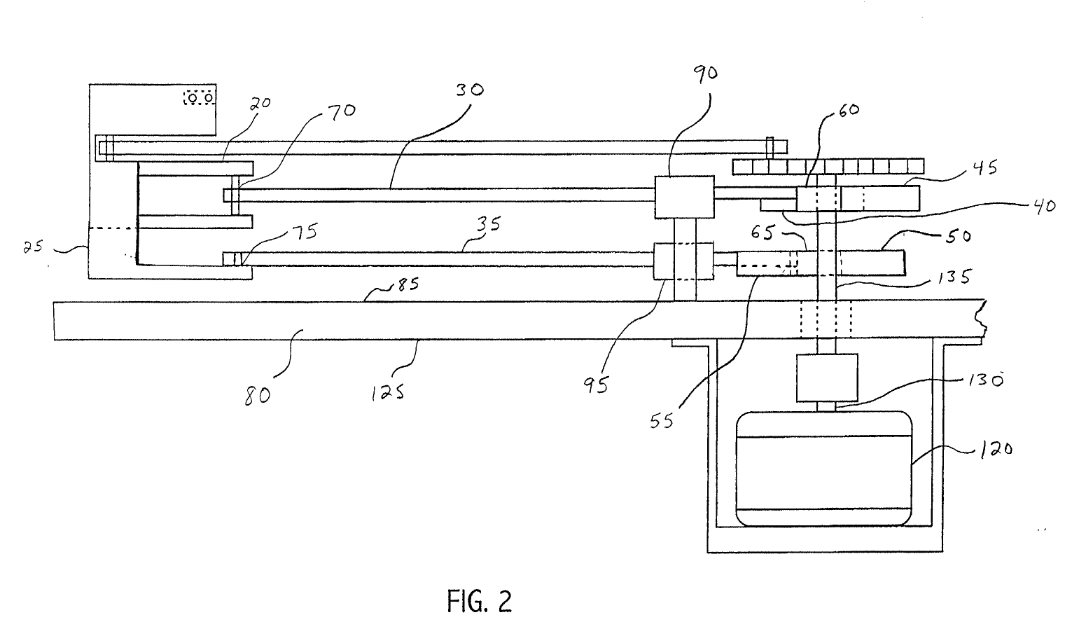

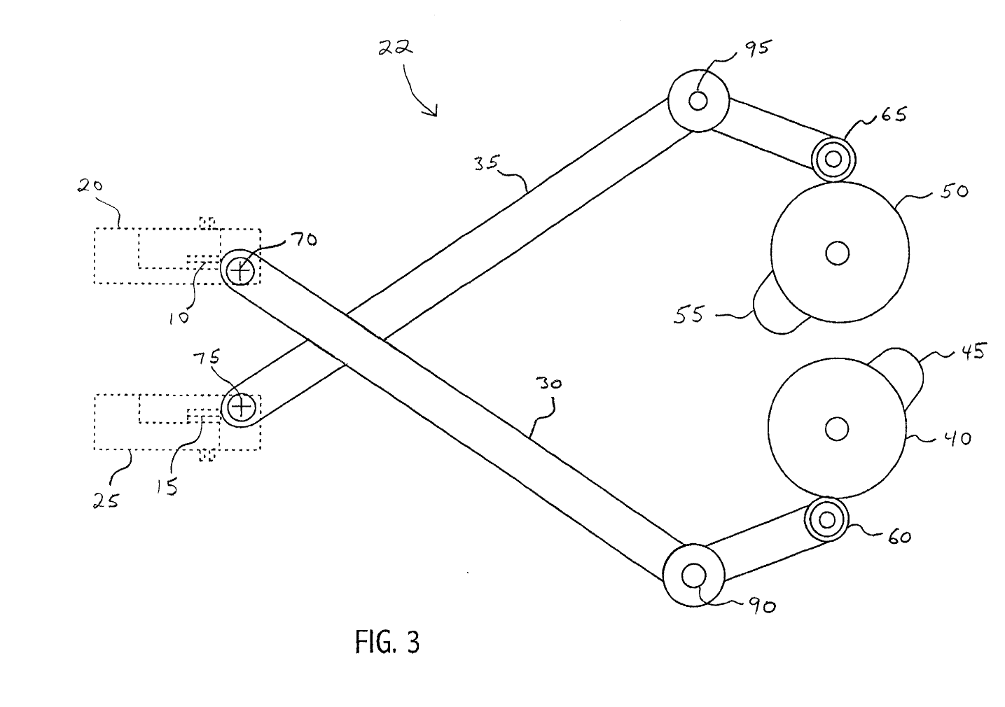

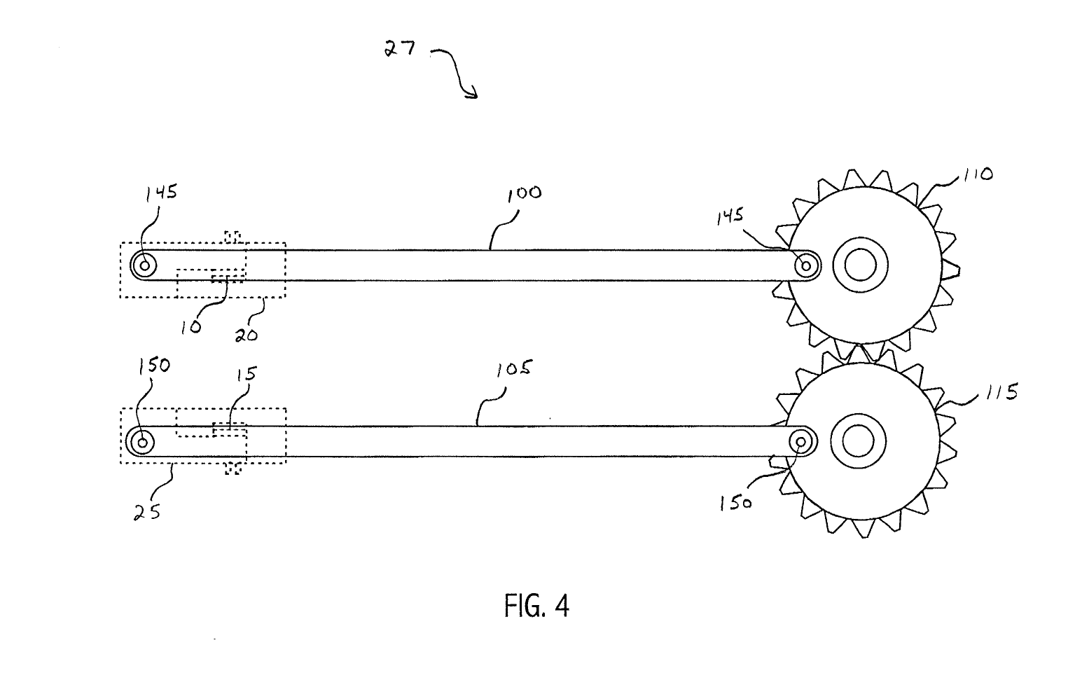

Referring now to the drawings where the illustrations are for the purpose of describing the preferred embodiment of the present invention and are not intended to limit the invention described herein, FIGS. 1-4 provide several views of the apparatus according to the present invention. The apparatus comprises a first clamp 10 and a second clamp 15 to secure a material 17, a first and second cam mechanism 22, 23 for stretching the material 17 by translating the first and second clamps 10, 15 in opposite directions, and a first and second gear mechanism 27, 28 for bending the material 17 by rotating the first and second clamps 10, 15 in opposite directions around the material 17. Preferably, the material 17 is a tissue sample. Although FIG. 1 shows both the first and second cam mechanisms 22, 23, one skilled in the art would recognize that a single cam mechanism could be utilized to stretch the material 17. The single cam mechanism would translate only one of the clamps away from the other instead of translating both clamps away from each other.

As stated earlier, the first clamp 10 and second clamp 15 are provided to secure the material. The clamp may be of any style suitable to secure the material 17 utilizing any type of locking mechanism known in the art. Further, each clamp 10, 15 may be attached to a fixture 20, 25 that provides a base for supporting the clamps and for connecting the clamps to the cam and gear mechanisms 22, 27. These fixtures 20, 25 also allow the position of the clamps to be adjusted on the fixtures 20, 25. Alternatively, it is possible to fabricate a one-piece clamp that includes these same features. For purposes of this application, the term “clamp” refers to both the clamp/fixture combination and the one-piece clamp design. One issue concerning the clamps is that they impact the radius of curvature undergone by the material during testing. The radius of curvature of the material ultimately achieved is dependent upon the thickness of the clamps and the space between the first and second clamp because the ends of the tissue can only get as close as the clamps allow. Therefore, the present invention may be designed to yield any desired radius of curvature by adjusting the thickness of the clamps and increasing or decreasing the space between the clamps. Because the space between the clamps may be minimal if a relatively small radius of curvature is desired, it is desirable that the locking mechanism of the clamp used to secure the material is located on the outside of the clamp to permit access to the locking mechanism.

The first cam mechanism 22 comprises a first lever 30, a first cam 40 having a lobe 45, and a first cam follower 60. The second cam mechanism 23 comprises a second lever 35, a second cam 50 having a lobe 55, and a second cam follower 65. Preferably, the lobes on both the first and second cams 40, 50 are symmetrical in that the up slope and the down slope of the lobes 45, 55 are the same. The first clamp 10 is pivotally connected to one end of a first lever 30 defining a first clamp pivot point 70. The first cam follower 60 is connected to the other end of the first lever 30 and engages the first cam 40. The second clamp 15 is also pivotally connected to one end of a second lever 35 defining a second clamp pivot point 75. The second cam follower 65 is connected to the other end of the second lever 35 and engages the second cam 50. The pivotal connections between the first and second levers 30, 35 and the first and second clamps 10, 15 are preferably pin joints, but may be any joint that permits rotation. Preferably, bearings are installed in the joints to minimize wear in the joints and promote smooth rotation. Also, the connections between the first and second levers 30, 35 and the first and second cam followers 60, 65 are preferably pin joints, but may be any joint that permits rotation. Preferably, bearings are installed in the joints to minimize wear in the joints and promote smooth rotation. The first and second levers 30, 35 may take any shape so long as the shape of they permit the transfer of the cam motion to the clamps. Preferably, the levers are L-shaped. The levers may be constructed of any suitable material for high-speed dynamic motion. Preferably, the levers are constructed of stainless steel. The first lever 30 permits the first clamp 10 to translate in a direction opposite of the second clamp 15 thereby stretching the material 17. The second lever 35 permits the second clamp 15 to translate in a direction opposite of the first clamp 10 thereby stretching the material 17.

In the creation of a machine to last several billion cycles, engineering principals recommend that a part that may fail be easily replaceable. Of all the parts in the apparatus in danger of fatigue failure, the cams will be the most expensive to replace because, preferably, they need to be precision cut and heat-treated for a long and accurate life. In addition, with the current design of the apparatus, replacing the cam is difficult, requiring complete disassembly of the apparatus and reorientation of the cams. Additionally, the apparatus uses specific geometric calculations for motion of the material. Wear of the cams will result in inaccurate motion of the material, therefore to protect the integrity of the cams, the cam followers should be made to fail earlier than the cams and thus should be made of a significantly softer material than the cams such as a relatively soft stainless steel. To this end, the cam follower should be relatively simple to replace using any common fastening means such as setscrews, split-clamps or any other fastening means in the art.

The apparatus 5 also includes a base 80 for support. The base 80 is typically a flat plate thick enough to support the weight of the apparatus. The first lever 30 is pivotally connected to the top surface 85 of the base 80 at a point disposed between each end of the first lever 30 defining a first lever pivot point 90. The second lever 35 is pivotally connected to the top surface 85 of the base 80 at a point disposed between each end of the second lever 35 defining a second lever pivot point 95. The pivotal connections between the first and second levers 30, 35 and the base are preferably pin joints, but may be any joint that permits rotation. Preferably, bearings are installed in the joints to minimize wear in the joints and promote smooth rotation.

The first gear mechanism 27 comprises a first link 100 and a first gear 110. The second gear mechanism 28 comprises a second link 105 and a second gear 115. The first clamp 10 is pivotally connected to one end of the first link 100 defining a first link pivot point 145 and the first gear 110 is pivotally connected to the other end of the first link 100. The second clamp 15 is pivotally connected to one end of the second link 105 and the second gear 115 is pivotally connected to the other end of the second link 105. The pivotal connections between the first and second links 100, 105 and the first and second clamps 10, 15 are preferably pin joints, but may be any joint that permits rotation. Also, the pivotal connections between the first and second links 100, 105 and the first and second gears 110, 115 are preferably pin joints, but may be any joint that permits rotation. Preferably, bearings are installed in the joints to minimize wear in the joints and promote smooth rotation. The first and second links 100, 105 may take any shape so long as the shape of the links permits the transfer of the gear motion to the clamps. Preferably, the links are straight. The links may be constructed of any suitable material for high-speed dynamic motion. Preferably, the links are constructed of stainless steel. Although gears are preferred in this invention, any rotatable member may be used in place of the gears. The first link 100 permits the first clamp 10 to pivot about the first clamp pivot point 70 and rotate in an arc in one direction around the material 17 thereby bending the material 17. The second link 105 permits the second clamp 10 to pivot about the second clamp pivot point 75 and rotate in an arc in the opposite direction around the material 17 thereby bending the material 17. Although a gear mechanism is preferred in the present invention, one skilled in the art would recognize that any means for rotating the first and second clamps 10, 15 in opposite direction around the material 17 would be permitted. Other means for rotation could include separate motors coupled to each of the clamps to rotate the clamps.

The present invention also includes a source of rotational motion to rotate the gears and the cams. Preferably, the source of rotational motion is a motor 120. The output of the motor 120 should provide enough torque so as to power up to four apparatuses. Therefore, the preferred output of the motor is 10 kW. The motor should be mounted to the bottom surface 125 of the base 80 to conserve space on the top surface 85 of the base 80. The motor shaft 130 is preferably coupled to a first shaft 135 using any standard coupling means known in the art. The first gear 110 is then coupled to the first shaft 135 using setscrews, split clamps, or the like. The second cam 50 is also coupled to the first shaft 135 by the same fastening means. However, one skilled in the art would appreciate that the first gear 110 and second cam 50 could be directly coupled to the motor shaft. Because the second cam 50 is coupled to the same first shaft 135 as the first gear 110, both the first gear 110 and the second cam 50 will rotate in the same direction.

Preferably, the present invention provides a second shaft 140 mounted to the top surface 85 of the base 80. To install the second shaft 140, a bearing is press fitted into a prefabricated hole in the base 80. The second shaft 140 is then inserted into the bearing. The second gear 115 is coupled to the second shaft 140 using setscrews, split clamps, or the like. The first cam 40 is also coupled to the second shaft by the same fastening means. Because the first cam is coupled to the same shaft 140 as the second gear 115, both the second gear 115 and the first cam 40 will rotate in the same direction. Preferably, the second gear 115 is meshed with the first gear 110 thereby causing the second gear 115 and first cam 40 to rotate in a direction opposite of the first gear 110 and second cam 50. Therefore, the single motor 120 provides the power to rotate and translate both of the clamps 10, 15. However, one skilled in the art would recognize that the gears need not be meshed together and a second motor (not shown) could be utilized to provide the rotational motion to rotate first clamp 10 and translate second clamp 15, while the motor 120 would rotate the second clamp 15 and translate the first clamp 10

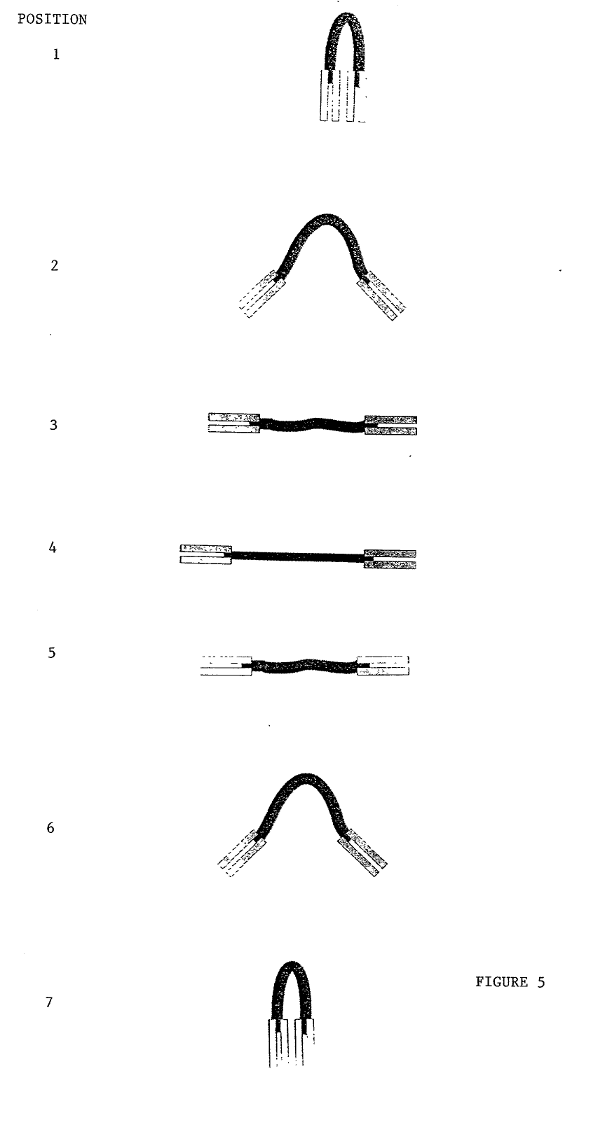

To demonstrate one complete testing cycle, see FIG. 5. In FIG. 5, the material 17 starts in a bent position (Position 1). The clamps 10, 15 are then rotated around the material 17 (Position 2) to a straight position (Position 3). The material is then stretched (Position 4) and unstretched (Position 5) a precise amount according to the size of the lobe on the rotating cam. The clamps 10, 15 are then rotated in the opposite direction thereby starting to bend the material (Position 6), and the material is brought back to the original bent position (Position 7). The degree of bending, radius of curvature, and amount of stretching can be adjusted by exchanging components of the system. Preferably, the apparatus will operate at a cycle rate of between 5 Hz to 100 Hz. More preferably, the apparatus will operate at a cycle rate of 10 Hz and 70 Hz. Even more preferably, between 20 Hz to 50 Hz. Most preferably, the apparatus will operate at a cycle rate of 50 Hz.

In operation, the present invention bends a material 17 a controlled amount during one complete testing cycle. The bending is accomplished by moving the clamps around the material, thereby minimizing total material motion. Also, to control the bending characteristics and avoid unwanted stress points, the clamps should be in parallel with the material ends at all times. See FIG. 6 for a demonstration of clamp motion as the gear rotates. When the motor 120 is activated, the first shaft 135 is rotated in a clockwise direction. The motor 120 can rotate the first shaft 135 either in a clockwise direction or a counter-clockwise direction; however, for the purposes of this application, the motor 120 rotates the shaft in a clockwise direction. When the first shaft 135 is rotated in a clockwise direction, the first gear 110 and second cam 50 are both rotated in a clockwise direction. As the first gear 110 rotates, the first link 100 causes the first clamp 10 to pivot about the first clamp pivot point 70 and rotate in an arc in a clockwise direction relative to the second clamp 15. Additionally, as the first gear 110 rotates in a clockwise direction, the second gear 115 and first cam 40 are rotated in a counter-clockwise direction because of the meshed relationship between the first gear 110 and second gear 115. As the second gear 115 rotates in a counter-clockwise direction, the second link 105 causes the second clamp 15 to pivot about the second clamp pivot point 75 and rotate in an arc in a counter-clockwise direction relative to the first clamp 10. Preferably, the first and second clamps 10, 15 are rotated 100 degrees in their respective directions. However, the first and second clamps 10, 15 may be rotated more or less depending on the desired application.

As discussed earlier, the present invention bends a material a controlled amount during one complete cycle by rotating the first and second clamps 10, 15 in opposite directions around the material. The amount of bending produced by the first clamp is determined by the distance between the first clamp pivot point 70 and the first link pivot point 145 relative to the radius of the first gear 110 (i.e., the distance between the center of the first gear 110 and the pivotal connection with the first link 100). The amount of bending produced by the second clamp 15 is determined by the distance between the second clamp pivot point 75 and the second link pivot point 150 relative to the radius of the second gear 115. Therefore, the amount of bending can be changed by: 1) changing the distance between the clamp pivot point and the link pivot point, and 2) moving the location of the pivotal connection of the link to the gear either closer to or further away from the center of the gear.

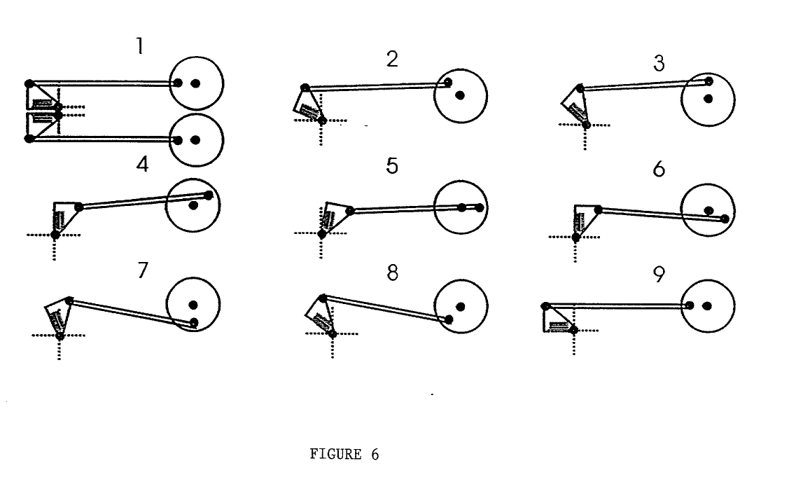

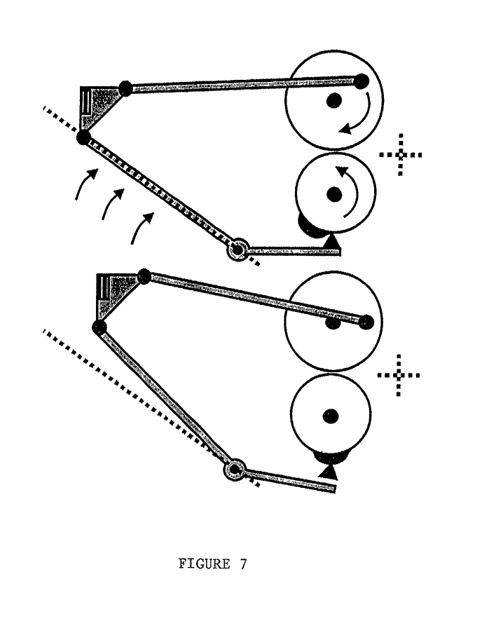

Also, the present invention stretches a material a controlled amount (when the material is straightened) during the same complete cycle. See FIG. 7 for a demonstration of the clamp motion when the cam follower engages the lobe on the cam. As the second cam 50 is rotated in a clockwise direction, the second cam follower 65 engages and follows the profile of the second cam 50. When the second cam follower 65 engages the lobe 55 on the second cam 50 (i.e., when both the first and second clamps 10, 15 are in a parallel orientation), the second lever 35 is deflected causing the second lever 35 to pivot about the second lever pivot point 95 thereby translating (moving the second clamp 15 in an arc away from the first clamp 10) the second clamp 15 in a direction opposite that of the first clamp 10. As the first cam 40 is rotated in a counter-clockwise direction, the first cam follower 60 engages and follows the profile of the first cam 40. When the first cam follower 60 engages the lobe 45 on the first cam 40 (i.e., when both the first and second clamps 10, 15 are in a parallel orientation), the first lever 30 is deflected causing the first lever 30 to pivot about the first lever pivot point 90 thereby translating (moving the first clamp 10 in an arc away from the second clamp 15) the first clamp 10 in a direction opposite that of the second clamp 15. This translational motion displaces the first and second clamps 10, 15 away from each other causing the material to stretch. According to this method, the angular motion of the first and second clamps through time will be close to sinusoidal.

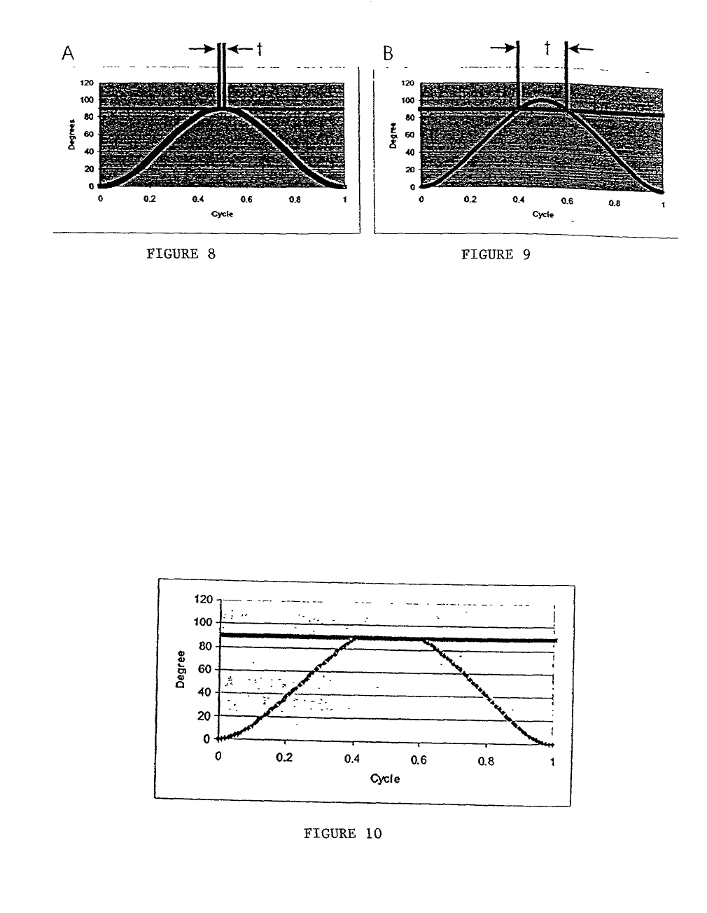

When the motion of the clamps is sinusoidal, there is no pause in the bending cycle during which the material could be stretched. If the clamps are set to rotate through 90°, the amount of time in which the clamps are in a straight line for stretching is very small (see FIG. 8). Therefore, the pivot geometry driving the first and second clamps 10, 15 is preferably modified causing the clamps to rotate through 100°, rather then 90°. In this case, the clamps will spend approximately 20% of their total cycle beyond 90°. Although the material will be stretched 20% of the time per cycle, the stretching percentage can be increased or decreased depending on the desired application. This is shown in FIGS. 9-10. During this added time, it is possible to stretch the material. By rotating the first and second clamps 10, 15 through mirrored arcs, the material can be stretched an amount depending on the height of the lobe on the cams. However, moving the clamps through these arcs not only changes the position of the clamps, but also changes the angle of rotation. Through careful geometry, the first and second lever pivot points 90, 95 may be preferably positioned so that the cam follower-cam action not only stretches the material, but also corrects for the over-rotation past 90°. During stretching, the material therefore remains straight, even though the gears driving the clamps continue to rotate.

As discussed earlier, the present invention stretches a material a controlled amount during one complete cycle by translating the first and second clamps in opposite directions. The amount of stretching produced by the first clamp 10 is determined by the size of the lobe 45 on the first cam 40. The amount of stretching produced by the second clamp 15 is determined by the size of the lobe on the second cam 50. The larger the lobe, the more the lever is deflected causing the clamp to translate a longer distance. Therefore, increasing the height of the lobe on the cam can increase the amount of stretching the material.

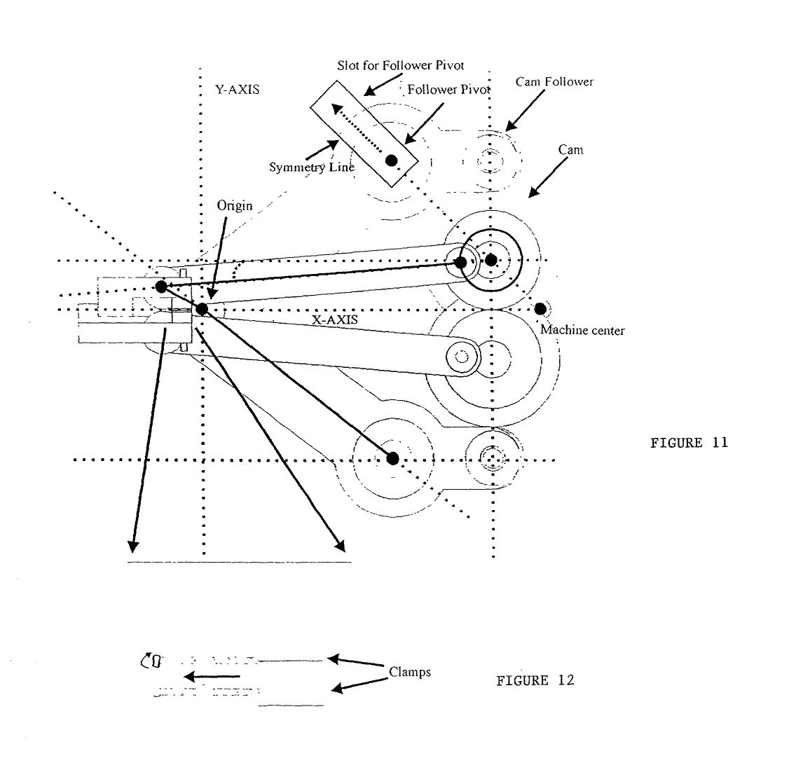

There are other methods to adjust the amount of stretching, however, these methods may require a few hardware modifications. The first method is changing the location of the lever pivot points. Although it is possible to change the location of the lever pivot points, it will only have an incremental effect on the cam lobe. Therefore, the height of the cam lobe may not need to be changed. By milling a slot in the base along the symmetry line (FIG. 11), the lever pivot point may be moved. Moving the lever pivot point out along this line will move the cam follower away from the cam, thus the cam follower must be moved to maintain its engagement with the cam. A second method for adjusting the amount of stretching is by changing the distance between the clamp and the clamp pivot point. Inherently, the distance between the ends of the material to be tested in the clamps depends on the distance between the clamps and their respective clamp pivot points. A simple screw-adjuster could be mounted between the fixture and the clamp to allow for the distance between the clamp and its respective clamp pivot point to be changed (FIG. 12), thereby allowing for adjustment. This would allow for adjustment in the distance between the clamps when the material is in a straight position.

In another embodiment according to the present invention, a first apparatus may be coupled with a second apparatus to conduct multiple material sample testing. To provide multiple material sample testing and to dynamically balance the apparatus, the present invention allows for multiple apparatuses (i.e., units) to be geared together to form a multiple material testing system (system). Just as reduction in the cam bump height will increase the life of the cam, reducing the vibrations of the entire system by creating dynamic balance will also increase the lifetime. One apparatus by itself is dynamically balanced in the vertical direction because all parts move and rotate in equal and opposite directions. In order to achieve dynamic balance in the horizontal direction, it is preferable to gear in another unit as a mirror reflection of the first unit. The second unit includes all the same parts as the first unit, except that the second unit shares the same base. The second unit includes a third gear 160 and a fourth gear 165 that are driven by the first and second gears 110, 115 of the first unit. The third gear 160 is meshed with the second gear 115 and therefore is rotated in a clockwise direction. The fourth gear 165 is meshed with both the first and third gears 110, 160 and therefore is rotated in the counter-clockwise direction. All the movements and motions of the clamps are the same for the second unit. Such a system allows for the testing of two material samples simultaneously, driven by one single motor.

Specifically, the second unit comprises a third clamp 170 and a fourth clamp 175 to secure a material 17, a second pair of cam mechanisms, and a second pair of gear mechanisms. The second pair of cam mechanisms comprises a third lever 190 and a fourth lever 195, a third cam 200 having a lobe 205 and a fourth cam 210 having a lobe 215, and a third cam follower 220 and a fourth cam follower 225. The third clamp 170 is pivotally connected to one end of the third lever 190 defining a third clamp pivot point 230. The third cam follower 220 is connected to the other end of the third lever 190 and engages the third cam 200. The fourth clamp 175 is pivotally connected to one end of the fourth lever 195 defining a fourth clamp pivot point 235. The fourth cam follower 225 is connected to the other end of the fourth lever 195 and engages the fourth cam 210. The third lever 190 permits the third clamp 170 to translate in a direction opposite of the fourth clamp thereby stretching the material 17. The fourth lever 195 permits the fourth clamp 175 to translate in a direction opposite of the third clamp 170 thereby stretching the material 17. The third lever 190 is pivotally connected to the top surface 85 of the base 80 at a point disposed between each end of the third lever 190 defining a third lever pivot point 240. The fourth lever 195 is pivotally connected to the top surface of the base 80 at a point disposed between each end of the fourth lever 195 defining a fourth lever pivot point 245.

The second pair of gear mechanisms comprises a third link 250, a fourth link 255, a third gear 160, and a fourth gear 165. The third clamp 170 is pivotally connected to one end of the third link 250 and the third gear 160 is pivotally connected to the other end of the third link 250. The fourth clamp 175 is pivotally connected to one end of the fourth link 255 and the fourth gear 165 is pivotally connected to the other end of the fourth link 255. The third link 250 permits the third clamp 170 to pivot about the third clamp pivot point 230 and rotate in an arc in one direction around the material 17. The fourth link 255 permits the fourth clamp 175 to pivot about the fourth clamp pivot point 235 and rotate in an arc in the opposite direction around the material 17.

The third gear 160 and fourth cam 210 are coupled to a third shaft 260 that is mounted to the top surface 85 of the base 80. To install the third shaft 260, a bearing is press fitted into a prefabricated hole in the base 80. The third shaft 260 is then inserted into the bearing. The third gear 160 is coupled to the third shaft 260 using setscrews, split clamps, or the like. The fourth cam 210 is also coupled to the third shaft 260 by the same fastening means. The fourth gear 165 and third cam 200 are coupled to a fourth shaft 265 that is mounted on the top surface 85 of the base 80. To install the fourth shaft 265, a bearing is press fitted into a prefabricated hole in the base 80. The fourth shaft 265 is then inserted into the bearing. The fourth gear 165 is coupled to the fourth shaft 265 using setscrews, split clamps, or the like. The third cam 200 is also coupled to the fourth shaft 265 by the same fastening means. Because the third gear 160 is meshed with the second gear 115, the third gear 160 and the fourth cam 20 rotate in a direction opposite of the second gear 115 and first cam 40. Because the fourth gear 165 is meshed with the first and third gears 110, 160, the fourth gear 165 and the third cam 200 rotate in a direction opposite of the first gear 110/second cam 50 and the third gear 160/fourth cam 210.

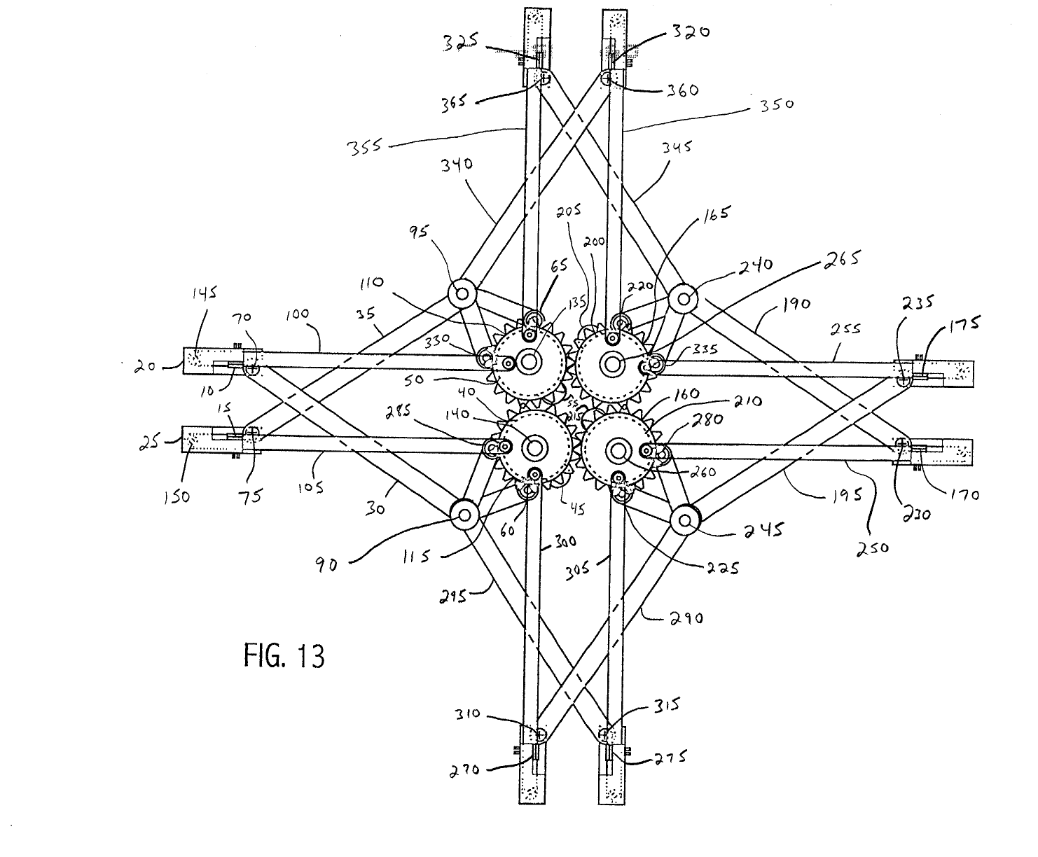

In yet another embodiment, the present invention may also include a third unit and a fourth unit (See FIG. 13). By gearing in units 90° to the first and second units, several parts can be shared between the four units. The third and fourth units include all the same parts as the first and second units, except that the third and fourth units do not have their own shafts, gears, and cam. The third and fourth units share the four gears, four cams, and four shafts with the first and second units along with the base. Such a system allows for the testing of four material samples simultaneously, driven by one single motor.

Specifically, the third unit comprises a fifth clamp 270 and a sixth clamp 275 to secure a material 17, a fifth cam follower 280 and a sixth cam follower 285, a fifth lever 290 and a sixth lever 295, and a fifth link 300 and a sixth link 305. The fifth clamp 270 is pivotally connected to one end of the fifth lever 290 defining a fifth clamp pivot point 310. The fifth cam follower 280 is connected to the other end of the fifth lever 290 and engages the fourth cam 210. Therefore, the fourth and fifth cam followers 225, 280 share the same cam (i.e., fourth cam 210). The sixth clamp 275 is pivotally connected to one end of the sixth lever defining a sixth clamp pivot point 315. The sixth cam follower 285 is connected to the other end of the sixth lever 295 and engages the first cam 40. Therefore, the first and sixth cam followers 60, 285 share the same cam (i.e., first cam 40). The fifth lever 290 permits the fifth clamp 270 to translate in a direction opposite of the sixth clamp 275 thereby stretching the material 17. The sixth lever 295 permits the sixth clamp 275 to translate in a direction opposite of the fifth clamp 270 thereby stretching the material 17. The fifth lever 290 is pivotally connected to the top surface 85 of the base 80 at the fourth lever pivot point 245. Therefore, the fourth and fifth levers 195, 290 share the same lever pivot point (i.e., fourth lever pivot point 245). The sixth lever 295 is pivotally connected to the top surface 85 of the base 80 at the first lever pivot point 90. Therefore, the first and sixth levers 30, 295 share the same lever pivot point (i.e., first lever pivot point 90).

The fifth clamp 270 is pivotally connected to one end of the fifth link 300 and the other end of the fifth link 300 is pivotally connected to the second gear 115. Therefore, the second and fifth links 105, 300 share the same gear (i.e., second gear 115). The sixth clamp 270 is pivotally connected to one end of the sixth link 305 and the other end of the sixth link 305 is pivotally connected to the third gear 160. Therefore, the third and sixth links 250, 295 share the same gear (i.e., third gear 160). The fifth link 300 permits the fifth clamp 270 to pivot about the fifth clamp pivot point 310 and rotate in an arc in one direction around the material 17. The sixth link 305 permits the sixth clamp 275 to pivot about the sixth clamp pivot point 315 and rotate in an arc in the opposite direction around the material 17.

Specifically, the fourth unit comprises a seventh clamp 320 and an eighth clamp 325 to secure a material 17, a seventh cam follower 330 and an eighth cam follower 335, a seventh lever 340 and an eighth lever 345, and a seventh link 350 and an eighth link 355. The seventh clamp 320 is pivotally connected to one end of the seventh lever 340 defining a seventh clamp pivot point 360. The seventh cam follower 330 is connected to the other end of the seventh lever 340 and engages the second cam 40. Therefore, the second and seventh cam followers 65, 330 share the same cam (i.e., second cam 40). The eighth clamp 325 is pivotally connected to one end of the eighth lever 345 defining a eighth clamp pivot point 365. The eighth cam follower 335 is connected to the other end of the eighth lever 345 and engages the third cam 200. Therefore, the third and eighth cam followers 220, 335 share the same cam (i.e., third cam 200). The seventh lever 340 permits the seventh clamp 320 to translate in a direction opposite of the eighth clamp 325 thereby stretching the material 17. The eighth lever 345 permits the eighth clamp 325 to translate in a direction opposite of the seventh clamp 320 thereby stretching the material 17. The seventh lever 340 is pivotally connected to the top surface 85 of the base 80 at the second lever pivot point 95. Therefore, the second and seventh levers 35, 340 share the same lever pivot point (i.e., second lever pivot point 95). The eighth lever 345 is pivotally connected to the top surface 85 of the base 80 at the third lever pivot point 240. Therefore, the third and eighth levers 190, 345 share the same lever pivot point (i.e., third lever pivot point 240).

The seventh clamp 320 is pivotally connected to one end of the seventh link 350 and the other end of the seventh link is pivotally connected to the fourth gear 165. Therefore, the fourth and seventh links 255, 340 share the same gear (i.e., fourth gear 165). The eighth clamp 325 is pivotally connected to one end of the eighth link 355 and the other end of the eighth link 355 is pivotally connected to the first gear 110. Therefore, the first and eighth links 110, 355 share the same gear (i.e., first gear 110). The seventh link 350 permits the seventh clamp 320 to pivot about the seventh clamp pivot point 360 and rotate in an arc in one direction around the material 17. The eighth link 355 permits the eighth clamp 355 to pivot about the eighth clamp pivot point 365 and rotate in an arc in the opposite direction around the material 17.

To accommodate space constraints, placement of the lever pivot points was chosen so that they could be shared with another unit. This can be done by placing the lever pivot point at the intersection of the pivot line and a line running at an angle of 45° from the center of the base, called the symmetry line. If the same lever pivot point is used for two units, the levers must be offset in the z-direction. For example, since the lever pivot point of the cam follower is located 45° from the center of the base, both the first and third units can use the same lever pivotal joint because they share the same pivot point.

Multiple units, each with links, levers, cam followers, bearings and clamps cause the system to become increasingly cluttered. With the possibility of using off-the-shelf gears and bearings, part overlap is inevitable. Parts were therefore offset in the z-direction, the plane perpendicular to the base. This simple method solves most of the overlap issues. The fixtures containing the clamps are particularly difficult to offset since they share several points in the x-y plane. For example, the first and sixth levers share the same coordinates for the first lever pivot point, and the respective clamps themselves must be in the same z-plane. In order to solve this problem, the first and sixth levers that share the same x-y coordinates may be offset in the z-plane and the respective parts may be elongated for proper clearance.

To increase the life of the apparatus and to add functionality, the present invention may include a number of additional features. Although all of these features are important, the present invention may include any combination of these features. To prevent the apparatus from wearing out, the cam should have a counter-balance. Creating a dynamically balanced system through the use of multiple apparatuses in the multiple testing system will increase the life of the machine. Similarly, it is necessary to offset the weight of the eccentricity in the cam to minimize the vibration of the cams themselves and prevent the cams from wearing out. Thus, the cam should have a counter-balance (i.e., weight) added to the appropriate location to offset the weight of the cam, reduce vibration, and increase the life of the apparatus.

In order to keep track of the apparatus cycle number, a cycle counter can be used. Such cycle counters are well known in the art and one skilled in the art would be able to provide the appropriate cycle counter for use in the present invention. One example of a cycle counter is where an LED could be installed to count each time a flag on one of the gears passes by a sensor. It is important to separate the cycle counter from the motor controller, so if the motor controller were to fail, the cycle number would still be recorded.

When the material to be tested is a tissue sample, it is preferred that a tissue humidifier system be installed to provide a constant supply of moisture to the tissue sample. To ensure normal tissue mechanics, the specimen should stay at body temperature (37° Celsius) and remain moist. It is thought that due to the high speed of the device (20-50 Hz), a simple fluid drip of heated Hanks solution would disperse upon hitting the tissue sample and thereby provide an area around the tissue that is heated to 37° C. and is 100% humid.

Just as the tissue needs hydration, the moving components of the apparatus need lubrication. In order to keep the gears and cams running smoothly, it is important to keep them constantly lubricated with a drip mechanism. This can be accomplished using an SKF Automatic Lubrication System mounted to drip directly onto the gears and cam followers. Because of the speed and setup of the machine (horizontal gears in an open space), the oil drip will spray oil in a wide arc. Of course, it is important that this oil does not splash onto the material (e.g., tissue sample) because it may damage the integrity of the tissue sample. Because the bearings are sealed, they do not need periodic lubrication, but collection of a salt solution from the tissue humidifier at the bottom of the base could contaminate the bearings. Also, salt solution may enter the lubrication drip mechanism and mix with the lubrication. Lubrication mixed with a salt solution could decrease the lifetime of the parts significantly. Therefore, a first fluid shield may be required to prevent the salt solution from reaching the gears, cams, cam followers, and bearings. Likewise, a second fluid shield may be required to prevent the lubrication from reaching the tissue sample.

Depending on how much fluid will be necessary to keep the tissue sample moist will determine whether troughs in the base are necessary. If the flow is high, then it will be necessary to collect the solution in the troughs and then pump it back up to the tissue humidifier system. If so, it would be very important that the lubrication does not contaminate the solution.

To address these issues, a first and second fluid shield may be provided to isolate the fluids and keep them separated. The first fluid shield will completely isolate the tissue sample from the lower half of the apparatus by placing a piece of sheet metal above the gearing, but below where the tissue sample is clamped. Slots may be cut into the fixture (i.e., clamp) that is connected to the tissue sample to allow the first fluid shield to slide below the tissue sample. The solution will then be deflected to the outside of the base, but inside the wall of the first fluid shield, to be collected in troughs around the outside.

The second fluid shield may be provided to isolate the lubrication from the salt solution by placing vertical partitions in strategic locations around the gears. These partitions will enclose the gears and cams so that the second fluid shield acts much like a gearbox, but will allow the links and levers to move through spaces cut in the partitions. To keep lubrication from going through these spaces, a system of tassels may be used that allows the links and levers to move freely through the space, but catches the lubrication as it is being sprayed. A drain may be provided in the near middle of the base to collect the lubrication.

Finally, the overall safety of the system should be examined to determine the necessary safety requirements. The system contains metal parts rotating at a maximum of 50 Hz. It is possible that one of the parts could break during use, therefore steps must be taken to ensure the safety of people surrounding the system. In addition, there are several rotating and articulating parts in the system, which create “pinch points” that could catch a person's finger or clothing causing them harm. Preferably, the system should be enclosed in an aluminum casing to prevent parts from flying off at high speeds and people from touching a moving part. The top of the system may be enclosed with a clear plastic shield because there is no motion in the vertical direction. Therefore, any part that fails will not have a significant velocity in the vertical direction. In addition, a kill switch should be provided to immediately cut power to the system in case of an emergency.

This apparatus could potentially collect a significant amount of information about why biological tissues fail. One particularly difficult problem with testing of biological tissue is the large variability between test specimens. Variability may make it necessary to test a large number of specimens in order to obtain statistically significant results. To obtain discriminating information from each test, it is important that the testing procedures are intelligent and well defined in order to reduce possible sources of experimental error. Qualitative aspects of the experiments, such as the modality of tissue failure, should also be collected to provide additional information about the tests. Other qualitative and quantitative information that could be obtained includes the direction of tissue failure with respect to collagen fiber orientation, creep of the tissue, extent and source of tissue degradation over time and the structural effect of collagen fiber fatigue through the different layers of the tissue

Various tests can be conducted on the apparatus according to the present invention. A tissue sample could be run until it fails and then cycle numbers compared between different types of tests. Alternatively, a tissue sample could be removed after a certain number of cycles and its failure strength tested on an Instron. The latter test would provide a quantitative number for the degradation of the tissue in relation to the number of cycles the tissue sample has undergone, as is done in traditional fatigue tests on hard specimens, but because of tissue variability it would be difficult to attain statistical significance between cycle numbers. For this reason, it is suggested that tests are initially designed to use cycles to failure as the quantitative criteria. Additional information could be obtained by periodically monitoring the change in extensibility of the tissue sample as it is fatigued. To do this, the tissue sample may need to be removed from the apparatus and tested by an Instron. In looking for a source of quantitative information, the ideal measure is the one least affected by tissue variability and most affected by tissue degradation. Possible ideas on parameters to monitor are the change in gauge length and amount of collagen fiber disruption.

The first material test of the device may be a comparison between fatigue failure of GPV tissue stretched and flexed in the radial or the circumferential direction. Collagen fiber orientation should theoretically make circumferentially cut tissue less resistant to bending then radially cut tissue. If specimens are run until failure, this simple materials test could provide information on the performance of the fatigue tester as well as the effect of tissue orientation on flexural fatigue of tissue. A host of other tests could be designed to provide additional information on the failure mechanism of replacement valve tissue by making minor changes to the testing parameters. With this apparatus, different tissue, such as porcine aortic valve cusps and bovine pericardium or tissue fixed by photoxidation and gluteraldehyde, could be compared. One test may be to correlate bending fatigue life of tissue to the thickness of the tissue. Theoretically, the thickening of the tissue due to fixation by gluteraldehyde creates greater bending strain on the tissue, so thicker tissue might be expected to fail quicker in bending fatigue. More advanced testing may involve comparison of different amounts of stretching or bending combinations. Finally, it would be important to compare cycling speeds for evaluating the reliability of high speed testing.

While this invention has been described with an emphasis upon a preferred embodiment, it will be obvious to those of ordinary skill in the art that variations of the preferred embodiment may be used and that it is intended that the invention may be practiced otherwise than as specifically described herein.

What is claimed is:

1. An apparatus comprising:
a first clamp to secure a material;
a second clamp to secure said material;
means for rotating said first clamp in a direction relative to said second clamp thereby bending said material;
means for rotating said second clamp in an opposite direction relative to said first clamp thereby bending said material; and
a first cam mechanism for translating said first clamp in a direction away from said second clamp thereby stretching said material,
wherein said apparatus bends and stretches said material within one cycle.

2. The apparatus of claim 1, wherein said first cam mechanism comprises:
a first cam having a lobe;
a first cam follower engaging said first cam; and
a first lever having a first and second end, said first end of said first lever is pivotally connected to said first clamp defining a first clamp pivot point, said second end of said first lever is pivotally connected to said first cam follower.

3. The apparatus of claim 2, further comprising a second cam mechanism for translating said second clamp in a direction away from said first clamp thereby stretching said material.

4. The apparatus of claim 3, wherein said second cam mechanism comprises:
a second cam having a lobe;
a second cam follower engaging said second cam; and
a second lever having a first and second end, said first end of said second lever is pivotally connected to said second clamp defining a second clamp pivot point, said second end of said second lever is pivotally connected to said second cam follower.

5. The apparatus of claim 4, wherein said means for rotating said first clamp is a first gear mechanism comprising:
a first gear; and
a first link having a first and second end, said first end of said first link is pivotally connected to said first gear, said second end of said first link is pivotally connected to said first clamp defining a first link pivot point.

6. The apparatus of claim 5, wherein said means for rotating said second clamp is a second gear mechanism comprising:
a second gear; and
a second link having a first and second end, said first end of said second link is pivotally connected to said second gear, said second end of said second link is pivotally connected to said second clamp defining a second link pivot point.

7. The apparatus of claim 6, wherein said first gear is meshed with said second gear.

8. The apparatus of claim 7, further comprising a motor coupled to a first shaft, said first gear and said second cam are coupled to said first shaft thereby associating said first gear mechanism with said second cam mechanism.

9. The apparatus of claim 8, further comprising a second shaft wherein said second gear and said first cam are coupled to said second shaft thereby associating said second gear mechanism with said first cam mechanism.

10. The apparatus of claim 9, further comprising a base wherein said first lever is pivotally connected to said base defining said first lever pivot point and said second lever is pivotally connected to said base defining said second lever pivot point.

11. The apparatus of claim 10, wherein said first gear and said second cam are rotated in one direction by said first shaft, said rotation of said first gear in one direction causes:
said first clamp to pivot about said first clamp pivot point and rotate in an arc in one direction relative to said second clamp; and
said second lever to pivot about said second lever pivot point and deflect when said second cam follower engages said lobe on said second cam thereby translating said second clamp in a direction opposite of said first clamp.

12. The apparatus of claim 11, wherein the meshing of said second gear with said first gear causes said second gear and said first cam to be rotated in an opposite direction, said rotation of said second gear and said first cam in the opposite direction causes:
said second clamp to pivot about said second clamp pivot point and rotate in an arc in the opposite direction relative to said first clamp; and
said first lever to pivot about said first lever pivot point and deflect when said first cam follower engages said lobe on said first cam thereby translating said first clamp in a direction opposite of said second clamp.

13. The apparatus of claim 1, wherein said material is a tissue sample.

14. The apparatus of claim 1, wherein said apparatus is operated at a cycle rate between about 20 Hz and about 50 Hz.

15. A system for testing multiple material samples comprising:
a first clamp and a second clamp to secure a first material sample;
a first pair of cam mechanisms connected to said first and second clamps, said first pair of cam mechanisms stretches said first material sample by translating said first and second clamps in opposite directions;
a first pair of gear mechanisms connected to said first and second clamps, said first pair of gear mechanisms includes a first gear and a second gear meshed with said first gear, said first pair of gear mechanisms bends said first material sample by rotating said first and second clamps around said first material sample;
a third clamp and a fourth clamp to secure a second material sample;
a second pair of cam mechanisms connected to said third and fourth clamps, said second pair of cam mechanisms stretches said second material sample by translating said third and fourth clamps in opposite directions; and
a second pair of gear mechanisms connected to said third and fourth clamps, said second pair of gear mechanisms includes a third gear meshed with said second gear and a fourth gear meshed with said first and third gears, said second pair of gear mechanisms bends said second material sample by rotating said third and fourth clamps around said second material sample,
wherein said system bends and stretches said first and second material samples within one cycle.

16. The system of claim 15, wherein said first pair of cam mechanisms comprises:
a first and second cam each having a lobe;
a first cam follower engaging said first cam;
a first lever having a first end and a second end, said first end of said first lever is pivotally connected to said first clamp defining a first clamp pivot point, said second end of said first lever is pivotally connected to said first cam follower;
a second cam follower engaging said second cam; and
a second lever having a first end and a second end, said first end of said second lever is pivotally connected to said second clamp defining a second clamp pivot point, said second end of said second lever is pivotally connected to said second cam follower.

17. The system of claim 16, wherein said second pair of cam mechanisms comprises:
a third cam and a fourth cam;
a third cam follower engaging said third cam;
a third lever having a first end and a second end, said first end of said third lever is pivotally connected to said third clamp defining a third clamp pivot point, said second end of said third lever is pivotally connected to said third cam follower,
a fourth cam follower engaging said fourth cam; and
a fourth lever having a first end and a second end, said first end of said fourth lever is pivotally connected to said fourth clamp defining a fourth clamp pivot point, said second end of said fourth lever is pivotally connected to said fourth cam follower.

18. The system of claim 17, wherein said first pair of gear mechanisms further comprises:
a first link having a first end and a second end, said first end of said first link is pivotally connected to said first gear, said second end of said first link is pivotally connected to said first clamp defining a first link pivot point; and
a second link having a first end and a second end, said first end of said second link is pivotally connected to said second gear, said second end of said second link is pivotally connected to said second clamp defining a second link pivot point.

19. The system of claim 18, wherein said second pair of gear mechanisms further comprises:
a third link having a first end and a second end, said first end of said third link is pivotally connected to said third gear, said second end of said third link is pivotally connected to said third clamp; and
a fourth link having a first end and a second end, said first end of said fourth link is pivotally connected to said fourth gear, said second end of said fourth link is pivotally connected to said fourth clamp.

20. The system of claim 19, further comprising:
a motor coupled to a first shaft, said first gear and said second cam are coupled to said first shaft;
a second shaft wherein said second gear and said first cam are coupled to said second shaft;
a third shaft wherein said third gear and said fourth cam are coupled to said third shaft; and
a fourth shaft wherein said fourth gear and said third cam are coupled to said fourth shaft.

21. The system of claim 20, further comprising a base wherein:
said first lever is pivotally connected to said base defining said first lever pivot point;
said second lever is pivotally connected to said base defining said second lever pivot point
said third lever is pivotally connected to said base defining said third lever pivot point; and
said fourth lever is pivotally connected to said base defining said fourth lever pivot point.

22. The system of claim 21, further comprising:
a fifth clamp and a sixth clamp to secure a third material sample;
a fifth cam follower engaging said fourth cam;
a fifth lever having a first end and a second end, said first end of said fifth lever is pivotally connected to said fifth clamp, said second end of said fifth lever is pivotally connected to said fifth cam follower,
a sixth cam follower engaging said first cam;
a sixth lever having a first end and a second end, said first end of said sixth lever is pivotally connected to said sixth clamp, said second end of said sixth lever is pivotally connected to said sixth cam follower;
a fifth link having a first end and a second end, said first end of said fifth link is pivotally connected to said second gear, said second end of said fifth link is pivotally connected to said fifth clamp; and
a sixth link having a first end and a second end, said first end of said sixth link is pivotally connected to said third gear, said second end of said sixth link is pivotally connected to said sixth clamp.

23. The system of claim 22, further comprising:
a seventh clamp and an eighth clamp to secure a fourth material sample;
a seventh cam follower engaging said second cam;
a seventh lever having first end and a second end, said first end of said seventh lever is pivotally connected to said seventh clamp, said second end of said seventh lever is pivotally connected to said seventh cam follower;
an eighth cam follower engaging said third cam;
an eighth lever having first end and a second end, said first end of said eighth lever is pivotally connected to said eighth clamp, said second end of said eighth lever is pivotally connected to said eighth cam follower;
a seventh link having a first end and a second end, said first end of said seventh link is pivotally connected to said fourth gear, said second end of said seventh link is pivotally connected to said seventh clamp; and
an eighth link having a first end and a second end, said first end of said eighth link is pivotally connected to said first gear, said second end of said eighth link is pivotally connected to said eighth clamp.

24. A method of fatigue testing a material comprising the steps of:
providing an apparatus having a first and second clamp to secure a material;
bending said material a controlled amount; and
stretching said material a controlled amount,
wherein said bending and stretching steps are accomplished within one cycle.

25. The method of claim 24, wherein said bending step includes rotating said first and second clamps in opposite directions around said material.

26. The method of claim 25, wherein said bending step is accomplished by a gear mechanism.

27. The method of claim 24, wherein said stretching step includes translating said first and second clamps in opposite directions.

28. The method of claim 27, wherein said stretching step is accomplished by a cam mechanism.

29. A method of fatigue testing multiple material samples comprising the steps of:
providing a system having at least two pairs of clamps to secure at least two material samples;
simultaneously bending at least two said material samples a controlled amount; and
simultaneously stretching at least two said material samples a controlled amount,
wherein said bending and stretching steps are accomplished within one cycle.

30. The method of claim 29, wherein said bending step is accomplished by a first and second gear mechanism.

31. The method of claim 29, wherein said stretching step is accomplished by a first and second cam mechanism.

32. The method of claim 29, wherein said system is capable of bending and stretching at least four material samples powered by a single motor.
